(19) United States
(12) Patent Application Publication
(10) Pub. No.: US 2006/0041469 A1
(43) Pub. Date: Feb. 23, 2006

(54) Marketing system employing electronically generated discount coupons

(76) Inventor: Torrance Mathis, Brooklyn, NY (US)

Correspondence Address: Alfred F. Hoyte, Esq., 7734 16th Street, N.W., Washington, DC, 20012, US

(21) Appl. No.: 10/920,322

(22) Filed: Aug. 18, 2004

(51) Int. Cl. G06Q 30/00

(52) U.S. Cl. 705/14

(57) ABSTRACT

A marketing system which uses electronically generated coupons to track specific consumers for the purpose of identifying a consumer's purchasing tendencies. The system allows the consumer to enjoy discount purchases with a wide variety of service and retail providers while simultaneously allowing the retail and service providers to identify the purchasing tendencies of a number of different consumer demographics. The coupon is in the form of a “scratch-off” card which has a plurality of occluded areas thereon. Beneath each of the occluded areas is indicia indicating the percentage or value of the discount, in predetermined amounts and increments. Before the consumer can begin purchasing the coupons, he must first register with a central computer which stores demographic data associated with the consumer. This stored data is transmitted via, e.g., the Internet, to a plurality of coupon dispensing devices strategically located at high pedestrian traffic areas such as malls. In addition to the occluded areas the coupon will include a bar code allowing for data to be gathered when the coupon is redeemed.

### BACKGROUND OF THE INVENTION

1. Field of the Invention

The present invention relates to marketing systems. More particularly, the invention is directed to a marketing system employing discount coupons to attract consumers and track their purchasing habits.

2. Description of the Prior Art

Discount coupons have been used for many years by retailers and service providers as a way of providing incentive for consumers to patronize their respective businesses. Typically, these coupons are distributed via various print mediums such as newspapers or magazines. Alternatively, the coupons can be distributed via mass mailings. In recent years discount coupons have been available electronically via the Internet. Some coupons are now distributed with bar codes, the information contained therein used solely to allow the retailer or service provider to track the number of times coupons are used for the various products/services to which they are tied.

The drawback to the traditional coupon systems is that they cannot be used to track and identify a customer base. Currently, the only systems in use to track customer purchasing are systems tied to the use of a specific credit card at a specific store. These systems can only be used to track an individual's purchases at a specific store and only when that individual uses a credit card, cash purchases typically cannot be tied to any specific consumer. Attempts to rectify this, such as having customers fill out forms and having the data entered into a computer system, are unwieldy and again, are tied to a specific retailer.

### SUMMARY OF THE INVENTION

The present invention is directed to a marketing system which uses electronically generated coupons to track specific consumers for the purpose of identifying a consumer's purchasing tendencies. The system allows the consumer to enjoy discount purchases with a wide variety of service and retail providers while simultaneously allowing the retail and service providers to identify the purchasing tendencies of a number of different consumer demographics. The coupon is in the form of a “scratch-off” card which has a plurality of occluded areas thereon. Beneath each of the occluded areas is indicia indicating the percentage or value of the discount, in predetermined amounts and increments. Before the consumer can begin purchasing the coupons, he must first register with a central computer, controlled by, e.g., a marketing agency, which stores demographic data associated with the consumer. This stored data is transmitted, on an as needed basis, via, e.g., the Internet, to a plurality of coupon dispensing devices strategically located at high pedestrian traffic areas such as malls. In addition to the occluded areas the coupon will include a bar code, allowing for data to be gathered when the coupon is redeemed.

It is a major object of this invention to provide a marketing system which uses discount coupons to attract consumers.

It is another object of the invention to provide a marketing system which allows for tracking the purchasing tendencies and history of a given customer at different retail outlets.

It is another object of the invention to provide a marketing system which uses coupons having bar codes imprinted thereon.

In accordance with one aspect of the invention, coupons are generated and distributed by a plurality of vending machines leased and licensed by a single licensing entity. The vending machines are positioned wherever groups of people gather or where there is heavy pedestrian traffic such as malls, airports, train stations, amusement parks, grocery stores, large retailers, franchises, parking lots, etc. Each coupon carries the logo or brand of the licensing entity and may alternatively additionally carry the logo or brand of a lessee. For example, machines located in a chain of stores may carry the store logo as well as the licensing entity logo. Each coupon is in the form of a “scratch-off” card having five occluded areas, each area having obscured indicia imprinted thereon. Four of the obscured indicia areas are aligned and conceal a percentage of discount, e.g., 40%, indicating that the user can get a 40% discount on a selected item at a participating retail/service provider. The fifth obscured indicia area, separate from the percentage indicia, conceals the selected item to be discounted, and may be redeemed at the participating, i.e., leased and licensed, retail/service provider. The discount may be as high as 100%; in such cases the scratch-off would spell the word “TIME” using the four aligned indicia areas. This would entitle the cardholder to a free item or service. The cardholder reveals the discount by “scratching off” the obscuring media. Each of the four obscured indicia areas indicate the same percentage, which is the total discount offered by the retailer/service provider.

In accordance with another aspect of the invention, each scratch-off card has a bar code imprinted thereon especially designed by the licensing entity/issuer and is read by the bar code reader at the time of dispensing. The bar code will include several data fields. First, the bar code will indicate the location of the dispensing unit and the organization associated therewith; second, the bar code will be associated with the magnetic strip membership data which allows the scratch-off to be identifiable to the scratch-off cardholder. The scratch-off discount coupon can only be dispensed from the dispensing unit by the user first inserting a pre-encoded magnetic strip card which can only be activated by giving one's personal data as will be explained in more detail below; third, the coupon transaction will be associated with a data field which is time and date stamped; and fourth, the bar code has a field indicator which identifies the precise discount of the scratch off as a hedge against redemption tampering. The prize to be discounted may also be incorporated into the code. Thus, once the scratch-off is redeemed and returned to the participating retailer for processing, extensive marketing data can be obtained. For example, for each card holder redeeming a scratch-off: the name, address, gender, age, time and date of scratch-off distribution, and time and date of scratch-off redemption is available. The licensing entity may then charge a fee for providing the marketing data, in various formats, to the various licensees and lessees.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 is a diagrammatic illustration of the method of the present invention.

FIG. 2A is an illustration of the discount coupon used with the method of the present invention.

FIG. 2B is an illustration of the discount coupon used with the method of the present invention with occluding media removed.

FIG. 2C is an illustration of the magnetic strip registration card used with the method of the present invention.

FIG. 3A is an illustration of a coupon dispensing apparatus to be used with the method of the present invention.

FIG. 3B is an illustration of a coupon redemption apparatus to be used with the method of the present invention.

### DETAILED DESCRIPTION OF THE PREFERRED EMBODIMENTS

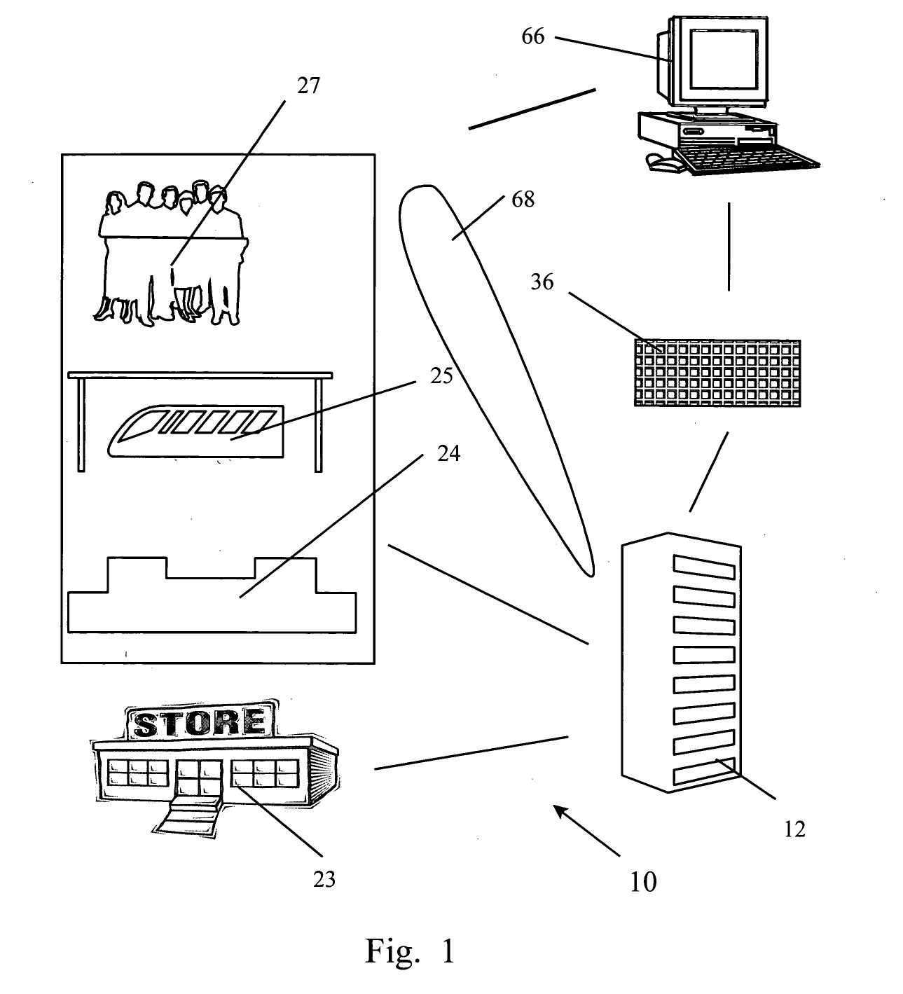

Referring now to FIGS. 1-3, the apparatuses and method of the present invention are illustrated. With particular reference to FIG. 1, the method is illustrated diagrammatically. Essentially, the method provides a licensing entity 12 or lessor, which may be a marketing agency, a means to obtain licensing/leasing fees from a variety of retail or service providers (i.e., the licensees or lessors) for distributing and facilitating the redemption of discount coupons related to the retail items or services of the various retail or service providers. Unlike prior art discount coupons, the discount coupons provide a retail/service provider a means to attract customers and track customer purchases. Additionally, extensive demographic data can be obtained by the licensing entity upon redemption, which can be catalogued and formatted as per the retailer or service provider's request. Various other promotional schemes can be implemented with the invention as will be discussed below. The licensing entity 12 tabulates and stores all data associated with the transactions of the discount coupons and provides this data to the retail/service providers in whichever form the retail/service provider requires.

The graphical overview of the deployment of the system, generally indicated by the numeral 10, is shown in FIG. 1. Distribution of the discount coupons or scratch-offs 20 as they are known in the trade is facilitated by placement of numerous dispensers 22 at places having high pedestrian traffic such as malls 24, bus or train stations 25, tourist attractions 27, etc. Potential consumers 21, who have become members or users of the system 10 in the manner prescribed below, can place a previously obtained magnetic card into the dispenser 22 and request one or more scratch-offs 20 daily by manipulation of the dispenser keypad 30. Once the scratch-off 20 is dispensed, the user may then scratch off the occluding media of one or more of the occluded areas 32 to reveal the amount of discount. The occluded area 34 may then be revealed so that the potential consumer can determine the item to be discounted. The retail service provider offering the item or service to be discounted will be imprinted upon the card. The consumer 21 may then, within the date limits also imprinted upon the scratch-off, redeem the coupon 20 by presenting it at the time of purchase. The coupon 20, which has a bar code imprinted thereon, will then be scanned by a bar code scanner so that data associated with the particular consumer can be transmitted to the licensing entity's central computer 36 where it is stored and tabulated. In accordance with one aspect of the invention, the licensing entity 12 receives a fee on a per transaction basis. The licensing entity 12 may also lease the dispensers 22 and charge leasing fees in addition to the transaction fees. Maintenance fees for maintaining the dispensers 22 may also be charged by the licensing entity 12. Finally, all data obtained from the various transactions described above may be stored, manipulated, and tabulated in accordance with predetermined or requested parameters, and reported back to the licensee/lessee which may be a chain of retail stores 23, giving the licensing entity 12 several ways to generate income practicing the method of the invention. It should be noted that the licensing entity 12 would have a web page hosted by the central computer 36 or by another arrangement as would be apparent to those of skill in the art.

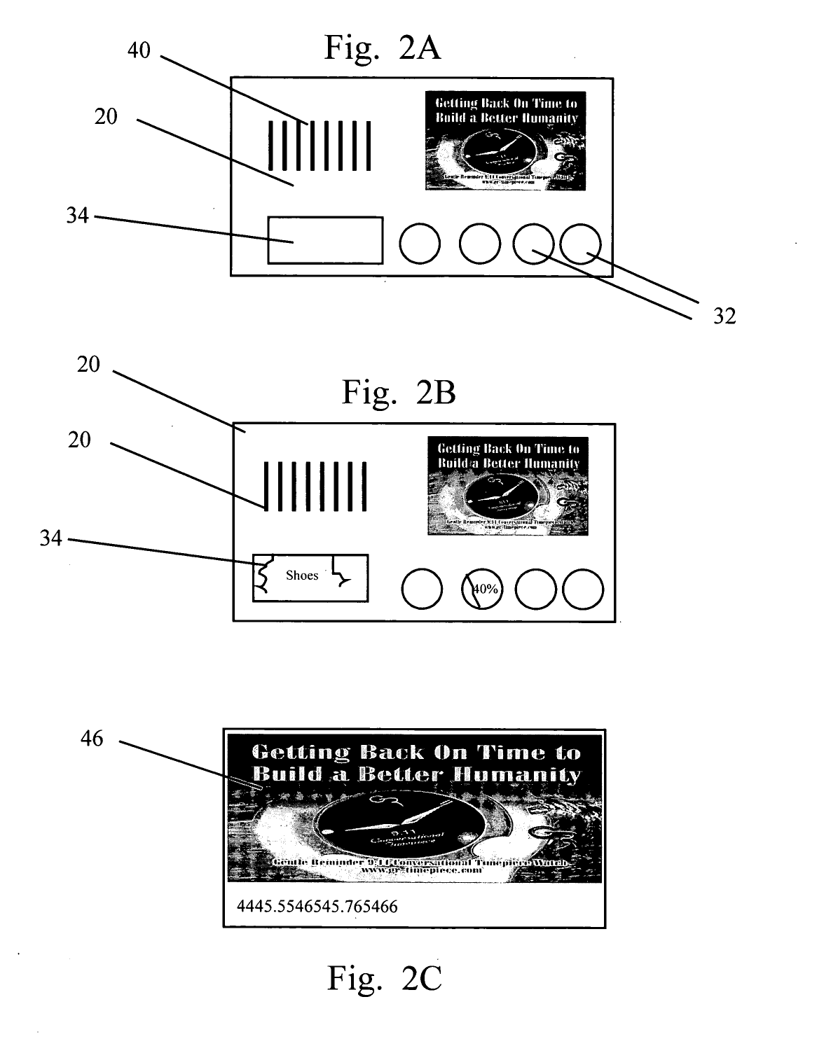

Referring now particularly to FIG. 2A, the scratch-off or discount coupon 20 is shown. The coupon 20 has a bar code 40 imprinted thereon as has been previously mentioned. The bar code 40 has several fields. First, the bar code 40 has a field indicating the location of the dispensing unit, preferably the specific location if there are several machines at a given site, (e.g., machine 312, 3^{rd} floor, Jones bldg) and the organization associated therewith. It should be noted that this information will be tied to the licensee (retail/servie provider) information as the loaction will be licensee specific. Thus, the bar code may optionally include licensee information. Of course, as each dispensing unit transmits a unique identifier signature, location and licensee information can be determined by real time or batch data transfer. Second, the bar code 40 will contain a unique number, specific to each individual coupon, to be associated with the magnetic strip membership data which allows the particular individual coupon 20 to be matched to a particular consumer at the time of distribution as will be explained in more detail later. The magnetic strip data, along with the other bar code data is transmitted real time or by batch down-loading to the central computer 36. Third, the bar code has a field indicating the discount and the product/service to which the discount is to be applied as a hedge against redemption tampering, as the bar code data must match the product and discount printed on the coupon. Thus, once the scratch-off is redeemed and returned to the participating retailer for processing, extensive marketing data can be obtained. For example, for each card holder redeeming a scratch-off the name, age, sex, city of residence, and other data supplied by the user at the time of registration can be known. Personal data such as address, phone number etc., will, of course, not be distributed by the licensing entity unless the consumer specifically requests such data be released. Permission to release this additional data may, after consumer authorization, be attached to the lessee's/retailer's account at the point of dispensing. The permission to release this information is specific only to the participating retailer/lessee. Lessees of dispensers 22 will have access only to data obtained or generated by the specific dispensers 22 leased by lessee. The use of address data may be used to target certain individuals for mass mailings or e-mails, which of course the user would have to agree to at the time the account is created.

Referring now to FIG. 2B, the magnetic strip card 46 is shown. This card 46 can be obtained from retailers, by telephonic or Internet request, or at any place the dispensers 22 are located. Once a user 21 has a card, he must activate the card 46 via Internet or telephone. Activation of the card 46, would require that the user submit a name, address, phone number, gender, and age at a minimum. Additional data such as social security number or visa number may be submitted, but in accordance with a preferred embodiment of the invention, such data is not submitted to ensure the privacy of the user 21 and to avoid the possibility of identity theft and other crimes.

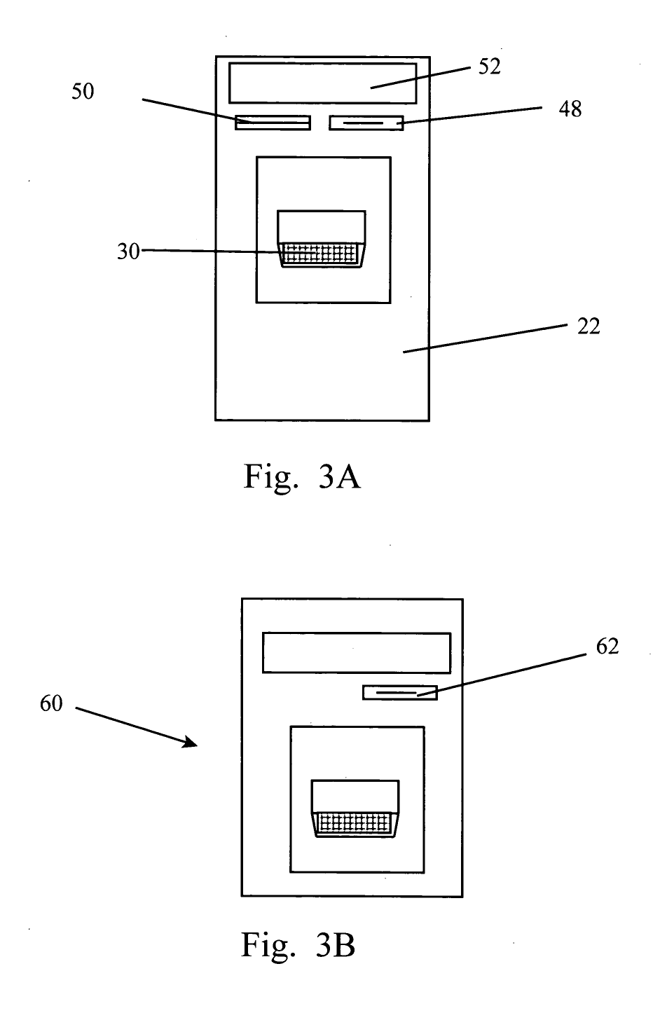

The dispenser 22 is shown in FIG. 3A. Each dispenser 22 includes a magnetic card reader 48 and associated slot, and a slot 50 for outputting coupons 20. The dispenser also includes a bar code reader for the reading the bar codes on the coupons 20 as they are dispensed. Additionally, the dispenser 22 includes a display 52 which is preferably remotely addressable from the central computer 26 to allow for displaying advertising messages and the like and changing the messages in real time. It should be noted that these types of dispensers 22 typically already have some type of display, and in accordance with the present invention, display 52 can be modified to be remotely addressable. Thus, for example, if placed in a stadium, the dispenser might display a message to identify a lessee (i.e. the retail/service provider) or for co-branding purposes. In addition, a lessee with a network of dispensers 22 may distribute different messages to the various dispensers 22 depending upon location. Lessees have the option of changing campaigns remotely through the central computer 36. A keypad 54 allows the user to enter commands to control the number of coupons 20 issued, inter alia, as may be required as more features are added to the method of the invention.

Referring now to FIG. 3B the coupon redemption device 60 is shown. A modified Verifone 3200se machine may be used for the redemption device. This machine is commonly used for credit card purchases with magnetic strip reader capabilities. Once modified, the redemption device 60 would have a barcode reader attachment and associated coupon entry slot 62 for the purpose of reading the barcode printed upon the scratch-off for redemption purposes. This allows retailers/service providers to have a precise accounting of customers (i.e. users) that receive their scratch-offs from remote locations and when the customer redeems the scratch-off. The current redemption system, as implemented with the device 60 will automatically discount the item purchased, account for the exact amount of money spent by a given cardholder including money spent on items other than the discounted items, time and date stamp each scratch-off related transaction, and link all transactions to the magnetic strip data field before transmitting all data to the central computer 36.

In addition to the stationary, kiosk type dispenser 22, the present invention can be implemented using mobile dispensers. These mobile dispensers 22 would operate in exactly the same way as stationary dispensers 22, with the obvious exception that the method of data communication would have to be wireless. Also, mobile dispensers 22 may be configured differently due to size constraints. For example, mobile dispenser 22 may be sized for installation in an urban mass transportation vehicle such as a bus or train. It should be noted that the stationary dispensers 22 may also communicate via RF or other wireless means to allow for temporary use at an event such as a golf tournament or corporate picnic, or any event held at a venue not likely to have heavy pedestrian traffic on a regular basis. Wireless communication between the mobile dispenser and the central computer may be accomplished using a point to point modem arrangement as would be apparent to one of skill in the art. The mobile dispensers 22 may be mounted on buses, trains, taxis, or other vehicles used for public transportation.

In operation, the user or consumer 21 will first obtain a magnetic strip card 46 by computer 66 via the Internet 68 or using any of the other means described above. Then, the consumers 21, who may be at the mall 24, train station 25, or other high trafiic area 27, can insert the magnetic strip card 46 into a conveniently placed dispenser 22 and request one or more coupons 20. In accordance with a preferred embodiment of the invention, the number of coupons per consumer 21 per machine, per transaction, is limited to 4 to avoid the dispensers 22, which have several compartments (not shown) for coupon storage, being depleted of cards. The dispensers 22 read the bar code of each coupon 20 dispensed, thereby linking the coupon 20 to a specific consumer 21 at the time of dispensing. The consumer 21 then, before the expiration date printed on the coupon, goes to a store 23 or other retail/service provider to redeem the coupon 20 by purchasing a discounted item. Participants are allowed a total of 8 coupons within a 24 hour period. Upon purchase of the discounted item by the consumer 21, the coupon 20 is inserted into the redemption device 60 which automatically discounts the item and transmits the information to the central computer 36 as described above. Since the coupon data is associated with a particular consumer 21 at the time the coupon 20 is dispensed, there is no need to insert the magnetic strip card 46 into the redemption device 60. Periodically, the central computer 36 tabulates all of the data obtained from the various transactions, and sends the data the licensee (retail/service provider) in a predetermined format.

In accordance with another aspect of the invention, participating children can log on to the central computer 36 and take lessons in math, science, and other subjects. For every lesson plan completed, credit will be added to the appropriate account which is loaded on the individual's file activated by the magnetic strip membership card 46. This will provide added bonuses and rewards as an incentive to encourage young students. The credit may be manifested as a coupon 20 giving a discount for an item which may be as high as 100% depending upon the amount of credit that the youth has obtained. The website hosted on the central computer 36 will include monitoring means to ensure actual participation in the lesson, such as intermittent prompts and queries requiring a response within a set time period. Coupons 20 for participating children will be dispensed by a dispenser 22 having specialized trade dress to be easily distinguished from dispensers 22 which primarily are used to target the adult demographic. Coupons 20 earned by a specific user may also be printed by the users personal computer. Dispensers for youths may also be provided with blank coupons and coupon printing means so that a youth may receive an “earned” coupon 20 directly from a dispenser. For record keeping purposes, magnetic cards 46 issued for youth purchases will be enumerated within a predetermined range so as to be distinguished from the adult demographic range. For example, youth cards may be enumerated from 000000 to 999999, with adult cards starting after 999999 at 1000000.

In accordance with another aspect of the invention, the central computer 36 includes motivational slogans as described in U.S. patent application Ser. No. 10/217,030 filed on Aug. 13, 2002, which is herein incorporated by reference. The motivational slogans may be generated at 9:11 a.m. and p.m. so that users logged on at those times can receive the slogans. The slogans may also be displayed by users as they log on, perhaps in response to a frequent buyer status or other triggering event associated with the user's account. For example, a user that has purchased and redeemed many coupons automatically receives the motivational slogans.

In order to allow for exchanging coupons 20 between users of the system, an internal exchange network provides users the ability to selectively exchange one discounted item for another. Users may log on to the licensor web page and select the appropriate icon to gain access to the exchange network. Afterwards the participant lists the coupons desired to be exchanged. Each coupon will be listed by category, automatically sorted in accordance with predetermined criteria by the central computer 26. Once a match is found the participants are notified via e-mail or automatic fax. Participants are given 24 hours from notification in order to approve the exchange. If not approved within 24 hours, the exchange is void. When both participants have approved the exchange, the data associated with the coupons 20 is exchanged. The participants then print a new transaction coupon 20 from their respective computers, the new coupons reflective of the data exchanged. For example, if user A has a coupon for a 20% discount on shoes at Payless ® and user B has a coupon for a 30% discount on golf apparel at Ross®, the bar code and other information associated with those products will be printed onto respective ones of the newly generated coupons 20. Thus, user A will then have a coupon for a 30% discount for golf apparel. An advantage of the system of the invention is that participants (i.e., consumers 21) are given incentive to search for customers desirous of purchasing a particular product, service or good offered by the system, with most of the “work”, i.e., the seeking of an acceptable match, being handled by the central computer 36.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. A marketing method for acquiring and tracking purchases of consumers utilizing discount coupons redeemable at participating retailers/service providers comprising:
providing each of said coupons with a bar code, and prearranged selectively occluded indicia;
dispensing said coupons from a plurality of strategically positioned coupon distribution devices to pre-registered consumers upon request;
storing transaction data specific to a redeeming one of said pre-registered consumers upon redemption by said redeeming consumer at one of said retailers/service providers and transmitting said data for storage in a central computer.

2. The method of claim 1 wherein said central computer is accessible via an Internet connection and further including the step of registering participating ones of said consumers on said central computer via said Internet connection.

3. The method of claim 1 further including the step of transmitting transaction data to said central computer from said coupon distribution devices upon dispensing of said coupons.

4. The method of claim 1 including the step of providing each of said consumers with a transaction enabling card, wherein activation of said transaction enabling card cannot occur until demographic data associated with a specific consumer is transmitted to and stored in said central computer.

5. The method of claim 4 wherein said discount coupons are dispensed only in response to insertion of said transaction enabling card into one of said coupon distribution devices, followed by manipulation of predetermined keys on said one of said coupon distribution devices by a consumer.

6. The method of claim 1 wherein cumulative transaction data is stored on said central computer, said cumulative transaction data tabulated and formatted by said central computer and transmitted to respective ones of said retail/service providers.

7. A marketing method allowing a marketing agency to acquire, tabulate, and format marketing data for a plurality of retail/service providers comprising:
providing coupon dispensers for each of said retail/service providers;
distributing discount coupons to pre-registered consumers upon request from said coupon dispensers associated with respective ones of said retail/service providers;
providing each of said coupons with a bar code, and prearranged indicia;
providing redemption terminals for each of said retail/service providers;
transmitting transaction data from said redemption terminals, said transaction data specific to a redeeming one of said pre-registered consumers, said transaction data transmitted upon redemption of one of said coupons by said redeeming consumer;
storing said transaction data on a central computer.

8. The method of claim 7 wherein said central computer is accessible via an Internet connection and further including the step of registering consumers on said central computer via said Internet connection.

9. The method of claim 7 further including the step of transmitting said bar code data from said coupons upon dispensing of said coupons.

10. The method of claim 7 including the step of providing each of said consumers with a transaction enabling card, wherein activation of said transaction enabling card cannot occur until demographic data associated with a specific consumer is transmitted to and stored in said central computer.

11. The method of claim 7 wherein cumulative transaction data is stored on said central computer, and including the step of tabulating and formatting said cumulative transaction data on said central computer and transmitting said formatted data to respective ones of said retail/service providers.

12. The method of claim 11 wherein fees are charged by said marketing agency for providing said formatted data to said retail/service providers.
